(19) United States
(12) Patent Application Publication
(10) Pub. No.: US 2019/0182557 A1
(43) Pub. Date: Jun. 13, 2019

(54) METHOD OF PRESENTING MEDIA

(71) Applicant: POWERCHORD GROUP LIMITED, London (GB)

(72) Inventor: Graham Tull, Guildford, Surrey (GB)

(21) Appl. No.: 16/324,492

(22) PCT Filed: Aug. 8, 2017
(86) PCT No.: PCT/GB2017/052335

§ 371 Date: Feb. 8, 2019

(30) Foreign Application Priority Data
Aug. 8, 2016 (GB) 1613588.1

(51) Int. Cl. H04N 21/6405; H04N 21/43; H04N 21/4363; H04N 21/4223

(52) U.S. Cl. CPC H04N 21/6405; H04N 21/4223; H04N 21/43637; H04N 21/4307

(57) ABSTRACT

A method of presenting media is provided. The method comprises receiving, using a receiver, a first wireless signal comprising the media, the media comprising a video component and an audio component; storing at least a component of the media in a memory of a video playback device separate from the receiver; selectively playing back the video component of the media using the video playback device; and playing back the audio component of the media using the receiver such that playback of the audio and video components of the media are synchronised. An apparatus and system for presenting media are also provided.

### TECHNICAL FIELD

The present disclosure relates to a method for presenting media and is particularly, although not exclusively, concerned with a method of presenting pre-show videos to attendees at a performance.

### BACKGROUND

Attendees at an event, such as a music concert, may use a personal audio receiver to receive a wirelessly transmitted signal comprising a high quality recording of sound, such as music, being produced by performers at the event. The attendees may listen to the high quality recording of the sound using the personal audio receiver in substantial time synchronisation with sound being received acoustically from the stage or from speakers provided at the event venue. Listening to the sound of the performance in this way may enhance the listening experience for the attendees.

The personal audio receiver may by paired with the attendee's smartphone using a two-way communication system such as Bluetooth®. The user may control the operation of the personal audio receiver using their smartphone.

### STATEMENTS OF INVENTION

According to an aspect of the present disclosure, there is provided a method of presenting media to a plurality of attendees to an event, the method comprising: receiving, using a plurality of receivers, a first wireless signal comprising the media, the media comprising a video component and an audio component; storing at least a component of the media in memories of a plurality of video playback devices separate from the receivers, each of the video playback devices being associated with a respective receiver; selectively playing back the video component of the media using one or more of the video playback devices; and playing back the audio component of the media using the receivers associated with the one or more video playback devices, such that playback of the audio and video components of the media is synchronised between each respective receiver and the video playback device associated with the receiver.

According to another aspect of the present disclosure, there is provided a method of presenting media, the method comprising: receiving, using a receiver, a first wireless signal comprising the media, the media comprising a video component and an audio component; storing at least a component of the media in a memory of a video playback device separate from the receiver; selectively playing back the video component of the media using the video playback device; playing back the audio component of the media using the receiver such that playback of the audio and video components of the media are synchronised.

The first wireless signal may be transmitted using a first wireless communication system. The first wireless communication system may be a broadcast system. In other words, the first wireless communication system may be configured to support unidirectional communication.

The method may further comprise transmitting at least a component of the media from the receiver to the video playback device using a second wireless communication system. Media may not be stored or may no longer be stored on the receiver after being transmitted to the video playback device. The media, e.g. a portion of the media, may be transmitted to the video playback whilst the media is being received, e.g. a subsequent portion of the media. Alternatively, the media may be transmitted to the video playback device after the media, e.g. the complete media, has been received.

The second wireless communication system may be configured to support two-way communication between the receiver and the video playback device. The receiver may be paired with the video playback device by virtue of the second communication system.

The media, e.g. one or more components or portions of the media, may be stored on the receiver, e.g. temporarily, when or whilst the media is received. The receiver may include a buffering memory. The method may comprise storing the media, or a component or portion of the media, within the buffering memory. The method may further comprise deleting the media from the receiver, e.g. from the buffering memory. The media may be deleted from the receiver after the media has been transmitted to the video playback device.

The method may further comprise receiving a user input at he video playback device requesting playback of the media.

The method may further comprise transmitting the audio component of the media from the video playback device to the receiver. The audio component of the media may be transmitted to the receiver using the second wireless communication system. The audio component of the media may be transmitted to the receiver at substantially the same time that the video component is played back by the video playback device.

The video playback device may comprise a camera. The method may comprise capturing an image of the receiver using the camera. The method may further comprise processing the image to determine an identity of the receiver. The video playback device may be configured to pair with the receiver using the second wireless communication system by applying the identity of the receiver.

The method may comprise transmitting the first signal using a transmitter remote from the receiver. The first signal may be transmitted over a range configured to cover the audience area of the event. For example, a power of the transmitter and/or the number of transmitters and/or further transmitter and the locations of the transmitters and/or further transmitters provided within the venue may be configured such that the first signal may be receiver throughout the audience area. The method may further comprise repeating the transmission of the first signal. The transmission of the first signal may be repeated until substantially all of, e.g. all of the data provided within, the first signal has been received by the plurality of receivers.

According to another aspect of the present disclosure, there is provided an apparatus for presenting media the media comprising an audio component and a video component, the apparatus comprising: a receiver, configured to receive a first wireless signal comprising the media, the media comprising an audio component and a video component; and a video playback device separate from the receiver, the video playback device comprising a memory; wherein the video playback device is configured to store at least a portion of the media in the memory; wherein the video playback device is configured to playback the video component of the media; and wherein the receiver is configured to play back the audio component of the media such that the playback of the audio and video components of the media are substantially synchronised.

The receiver may comprise a first wireless communication system configured to receive the first wireless signal. The first wireless communication system may be a unidirectional wireless communication system.

The receiver may be configured to transmit the media to the video playback device. The receiver may comprise a second wireless communication system. The receiver may be configured to transmit the media to the video playback device using the second wireless communication system. The second wireless communication system may be configured to support two-way communication between the receiver and the video playback device.

The video playback device may comprise a camera, e.g. a digital camera. The camera may be integral within the video playback device. The receiver may comprise a visual identifier, e.g. a barcode or two-dimensional barcode, such as a QR Code®. The video playback device may be configured to capture an image of the visual identifier. The video playback device may be further configured to process the image to determine an identity of the receiver.

The video playback device may be configured to pair with the receiver using the second communication system, e.g. according to the determined identity of the receiver. The video playback device may receive the media by virtue of its paring with the receiver.

The receiver may comprise a buffering memory. The receiver may be configured to store the media in the buffering memory when the media is received, e.g. when the first signal is being received. The receiver may be configured to delete the media, e.g. from the buffering memory, after the media has been transmitted to the video playback device.

The receiver may be configured to receive media files of a size greater than can be stored by the receiver, e.g. in the buffering memory. The receiver may be configured to transmit one or more portions of the media to the video playback device and delete the portions of the media from the receiver, e.g. from the buffering memory, whilst the media, e.g. a further portion of the media, is being received.

The video playback device may be configured to transmit the audio component of the media to the receiver at substantially the same time that the video component is being played back by the video playback device.

According to another aspect of the present disclosure, there is provided a system for presenting media to a plurality of attendees at an event, the system comprising: a plurality of apparatuses according to a previously mentioned aspect of the disclosure; and a transmitter configured to broadcast the first wireless signal.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1a is a schematic view of a system for presenting media to a plurality of attendees at an event, according to arrangements of the present disclosure;

FIG. 1b is a schematic view showing the process of recording, processing and reproducing sound within the arrangement shown in FIG. 1a;

FIG. 2 is a schematic view of an apparatus for presenting media according to arrangements of the present disclosure; and

FIG. 3 shows a method of presenting media according to arrangements of the present disclosure.

FIG. 4 shows a method of synchronising an audio signal, according to an arrangements of the present disclosure; and

FIG. 5 shows a method of synchronising an audio signal, according to another arrangement of the present disclosure.

### DETAILED DESCRIPTION

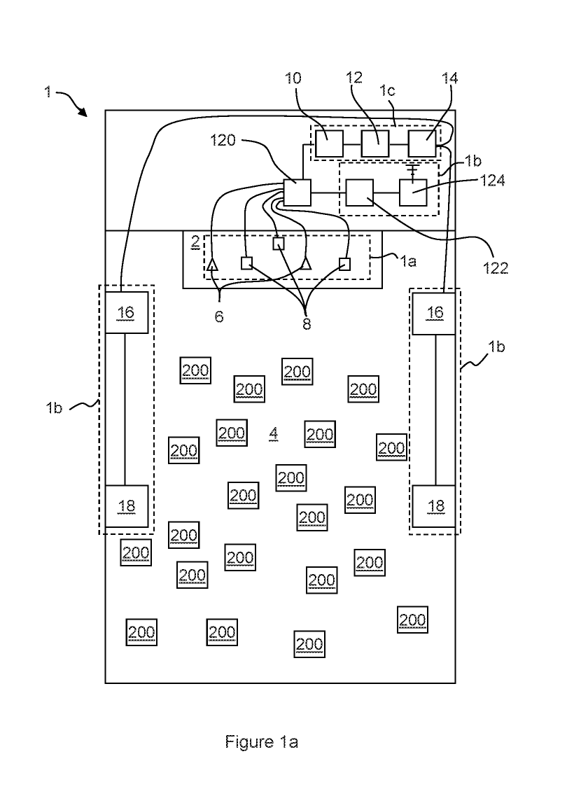

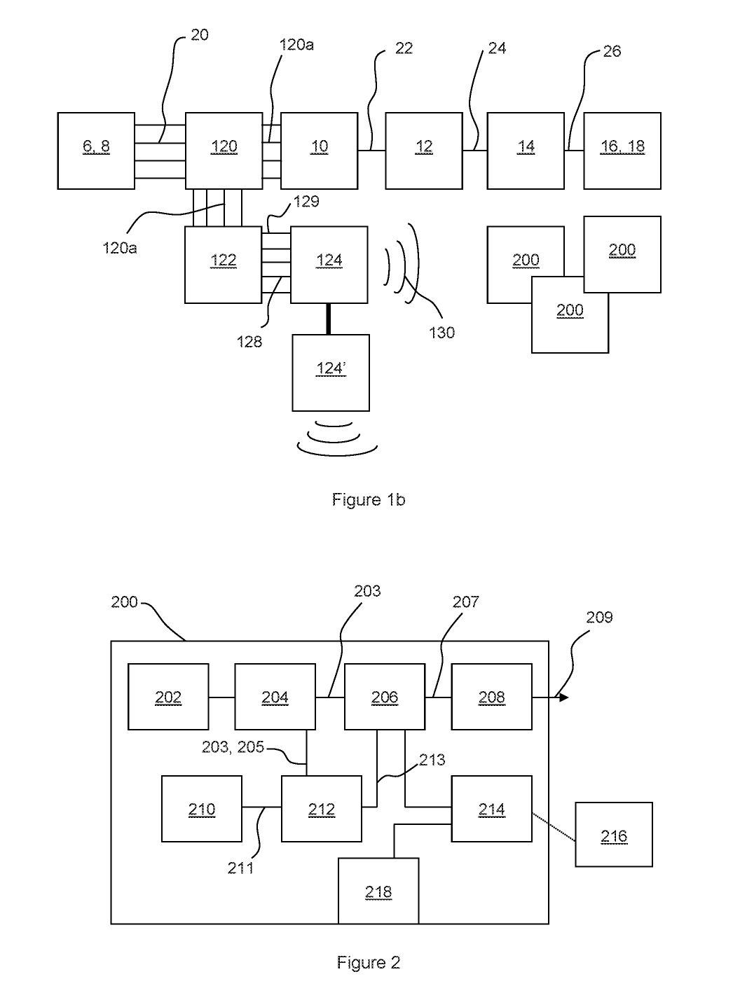

With reference to FIG. 1a, a venue for a concert or other live event comprises a performance area, such as a stage 2, and an audience area 4. The audience area may comprise one or more stands of seating in a venue such as a theatre or arena. Alternatively, the audience area may be a portion of a larger area such as a park, within which it is desirable to see and/or hear a performance on the stage 2. In some cases, the audience area 4 may be variable, being defined by the crowd of people gathered for the performance.

A media system 1 may be provided within the venue to capture the sound produced by performers on the stage 2, process the sound and project the processed sound into the audience area 4 such that all attendees are able to hear the performance.

With reference to FIGS. 1a and 1b, the media system 1 comprises stage recording equipment 1a, configured to record sounds being produced by performers on the stage; sound projection equipment 1b, configured to process the sound from the performers and project the sound throughout the venue; and sound broadcast equipment 1c, configured to broadcast a wireless signal comprising a high quality recording of the sound from the performers throughout the venue.

As depicted in FIG. 1a, the media system 1 may further comprise a plurality of portable audio receivers 200. Some or each of the attendees at the event may use the audio receivers 200 to receive the wireless signal from the sound broadcast equipment 1c and reproduce the high quality recording of the sound. The attendees may listen to the high quality recording in substantial time synchronisation with the acoustic sound being projected throughout the venue by the sound projection equipment 1b.

As shown in FIG. 1a, the stage equipment 1a may comprise one or more microphones 6 and/or one or more instrument pick-ups 8. The sound produced by instrumentalists and vocalists performing on the stage 2 is picked up by one or more microphones 6 and/or one or more instrument pick-ups 8 and converted into a plurality of audio signals 20 that are provided to the sound projection equipment 1b and the sound broadcast equipment 1c.

The sound projection equipment 1b comprises a stage mixer 10, a stage equaliser 12, a stage amplifier 14 and a plurality of speakers 16, 18.

The stage mixer 10 receives the audio signals 20 from the stage equipment 1a and may adjust the relative volumes of each of the audio signals according to a stage mix setting. The stage mix setting may be set by an audio technician prior to and/or during the performance. The relative volumes may be selected to provide what the audio technician considers to be the best mix of instrumental and vocal sounds to be projected throughout the venue. In some cases performers may request that the mix is adjusted according to their own preferences.

A mixed, e.g. combined, audio signal 22 output by the stage mixer is input to the stage equaliser 12, which can be configured to increase or decrease the volume of certain frequency ranges within the mixed audio signal 22. The equalisation settings may be similarly selected by the audio technician and/or performers according to their personal tastes and may be at least partially selected according to the acoustic environment of the venue and the nature of the performance.

A mixed and equalised audio signal 24, output by the stage equaliser 12 is then input to the stage amplifier 14, which boosts the audio signal to provide an amplified stage audio signal 26. The amplified audio signal 26 is provided to one or more front speakers 16 arranged to project the audio signal as sound into the audience area 4. Additional speakers 18 may also be provided within the sound projection equipment 1b. In the arrangement shown in FIG. 1a, the additional speakers 18 are located within the audience area 4, and are configured to project the mixed and equalised audio to attendees located towards the back of the audience area 4.

Sound from the front speakers 16 reaches audience members towards the back of the audience area 4 a short period of time after the sound from the additional speaks 18. In large venues, this delay may be detectable by the audience members and may lead to echoing or reverb type effects. In order to avoid such effects, the audio signal provided to the additional speakers 18 is delayed before being projected into the audience area 4. The signal may be delayed by the additional speakers 18, the stage amplifier 14, or any other component or device within the arrangement 1. Sound from the speakers 16 and the additional speakers 18 will therefore reach an attendee towards the rear of the audience area 4 at substantially the same time, such that no reverb or echoing is noticeable.

Owing to the mixed and equalised sounds being reproduced by multiple speaker systems throughout the venue, some of which are configured to delay the signal before reproducing the sound, interference may occur between the projected sounds waves in certain areas of the venue, which deteriorates the quality of audible sound. For example, certain instruments and/or vocalists may become indistinguishable, not clearly audible or substantially inaudible within the overall sound. In addition to this, the acoustic qualities of the venue may vary according to the location within the venue and hence the equalisation of the sound may be disrupted for some audience members. For example, the bass notes may become overly emphasised.

As described above, the mix and equalisation of the sound from the performance may be set according to the personal tastes of the audio technician and/or the performers. However, the personal tastes of the individual audience members may vary from this and may vary between the audience members. For example a certain audience member may prefer a sound in which the treble notes are emphasised more than in the sound being projected from the speakers, whereas another audience member may be particularly interested in hearing the vocals of a song being performed and may prefer a mix in which the vocals are more distinctly audible over the sounds of other instruments.

By providing the sound broadcast equipment 1c and the personal audio receivers 200, as described in detail below, within the audio system 1, each audience member may be able to experience an improved quality and consistency of audio and may be able to adjust the mix and equalisation of the audio individually.

The audio broadcast equipment 1c comprises an audio workstation 122 and a transmitter 124. As depicted in FIG. 1, when the audio system 1 comprises the audio projection equipment 1b and the audio broadcast equipment 1c, the system may also comprise a stage audio splitter 120. The stage audio splitter 120 may be provided between the stage audio equipment 1a, and the audio projection equipment 1b and audio broadcast equipment 1c. The stage audio splitter 120 may be configured to receive the audio signals 20 from each of the microphones 6 and instrument pick-ups 8, and split the signals to provide inputs 120a to the stage mixer 12 and the audio workstation 122. The inputs received by the stage mixer and the audio workstation may be substantially the same as each other and may be substantially the same as the audio signals 20 from the stage audio equipment 1c.

The audio workstation 122 may comprise one or more additional audio splitting and mixing devices (not shown), which are configured such that each mixing device is capable of outputting a combined audio signal 128 comprising a different mix of each of the input audio channels 20 received from the stage audio splitter 120. For example, the relative volumes of each of the input audio channels 20 within each of the combined audio signals 128 may be different from the relative volumes of each of the input audio channels 20 within each of the other combined audio signals 128 output by the audio workstation 122. At least one of the combined audio signals 128 generated by the audio workstation 122 may correspond to the stage mix being projected from the speakers 16 and additional speakers 18.

As depicted in FIG. 2, the audio workstation 122 may be configured to generate four combined audio signals 128. However, it is equally envisaged that the audio workstation 122 may be configured to generate 2, 3, 5 or any desirable number of combined audio signals 128. In some arrangements, the audio workstation 122 may comprise a computing device configured to process the input audio channels 120a from the stage audio splitter 120 to generate the plurality of combined audio signals 128. Alternatively, the audio workstation 122 may comprise any other system capable of generating the combined audio signals 128.

In some arrangements, the audio workstation 122 may also be configured to generate an audio content that is substantially the same as the stage mix generated by the stage mixer 10. The audio content may be configured to correspond to the sound projected from the speakers 16 and the additional speakers 18. The audio workstation 122 may be configured to process the audio content to generate metadata 129, e.g. a metadata stream, corresponding to the audio content. The metadata describes the audio content, for example, the metadata may relate to the waveform of the audio content. Additionally or alternatively, the metadata may comprise timing and/or frequency information relating to the audio content. The metadata may be generated by the audio workstation 122 substantially in real time, such that the stream of metadata 129 is synchronised with the combined audio signals 128 output from the audio workstation 122.

The combined audio signals 128 and metadata 129 output by the audio workstation 122 are input to the transmitter 124. The transmitter 124 is configured to transmit the combined audio signals 128 and metadata 129 as one or more wireless signals 130, using a wireless communication system, such as radio, digital radio, Wi-Fi®, or any other wireless communication system. The transmitter 124 may also be capable of relaying the combined audio signals 128 and metadata 129 to one or more further transmitters 124′ provided within the audio broadcast equipment 1c using a wired or wireless communication method. Relaying the combined audio signals and metadata allows the area over which the combined audio signals and metadata is transmitted to be extended. The wireless signals 230 transmitted by the transmitter 124 and any further transmitters 124′ are received by each of the personal audio receivers 200.

Each of the combined audio signals 128 and the metadata 129 may be transmitted separately using a separate wireless communication channel, bandwidth, or frequency. Alternatively, the combined audio signals 128 and metadata 129 may be modulated, e.g. digitally modulated, and/or multiplexed together and transmitted using a single communication channel, bandwidth or frequency. For example, the combined audio signals 128 and metadata 129 may be encoded using a Quadrature Amplitude Modulation (QAM) technique, such as 16-bit QAM. The wireless signals 130 transmitted by the transmitter 124 are received by the plurality of personal audio mixing devices 200.

The wireless signal 130 sent by the transmitter 124 may be transmitted using an ultra low latency transfer protocol, such as the ULoLat protocol. In order to allow the latency of communications between the transmitter 124 and the personal audio receivers 200 to be low, the transmitter 124 may be configured to operate in a broadcast only mode. The personal audio receivers 200 may be configured not to send any acknowledgement messages to the transmitter 124 to confirm that the wireless signals 130 have been received. The transmitter 124 may continue sending the wireless signal 130 without receiving any acknowledgement messages.

With reference to FIG. 2, the personal audio receiver 200, according to an arrangement of the present disclosure, comprises an audio signal receiver 202, a decoder 204, a personal mixer 206, and a personal equaliser 208.

The audio signal receiver 202 is configured to receive the wireless signal 130 comprising the combined audio signals 128 and metadata 129 transmitted by the transmitter 124. As described above, the multi-channel transmitter 124 may encode the signal, for example using a QAM technique. Hence, the decoder 204 may be configured to demultiplex and/or demodulate (e.g. decode) the received signal as necessary to recover each of the combined audio signals 128 and metadata 129, as one or more decoded audio signals 203 and wirelessly received metadata 205.

As described above, the combined audio signals 128 may each comprise a different mix of audio channels from the stage splitter 120, which have been recorded from the instrumentalists and/or vocalists performing on the stage 2. For example, a first combined audio signal may comprise a mix of audio channels in which the volume of the vocals has been increased with respect to the other audio channels; in a second combined audio signal the volume of an audio channel from the instrument pick-up of a lead guitarist may be increased with respect to the other audio channels.

The personal mixer 206 is configured to vary the relative volumes of each of the decoded audio signals 203 to create a personal mix to be listened to by the user of the personal audio receiver 200. The mix created by the personal mixer 206 may be selectively controlled by a user of the personal audio receiver 200, as described below. The user may set the personal mixer 206 to create a mix of one or more of the decoded audio signals 203.

In a particular arrangement, each of the combined audio signals 128 is mixed by the audio workstation 122 such that each signal comprises a single audio channel 20 recorded from one microphone 6 or instrument pick-up 8. The personal mixer 206 can therefore be configured by the user to provide a unique personalised mix of audio from the performers on the stage 2. The personal audio mix may be configured by the user to improve or augment the ambient sound, e.g. from the speakers and additional speakers 16, 18, heard by the user. A mixed audio signal 207 output from the personal mixer 206 is processed by the personal equaliser 208. The personal equaliser is similar to the stage equaliser 12 described above and allows the volumes of certain frequency ranges within the mixed audio signal 207 to be increased or decreased. The personal equaliser 208 may be configured by a user of the personal audio receiver 200 according to their own listening preferences. An equalised audio signal 209 from the personal equaliser 208 is output from the personal audio mixing device 200.

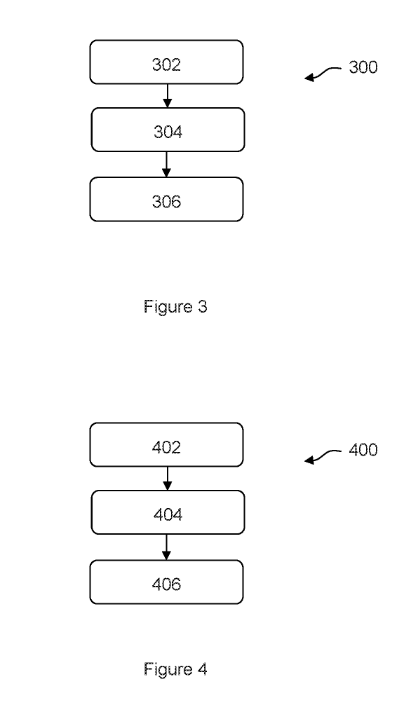

As shown in FIG. 3, the personal audio receiver 200 may comprise one or more audio transducers 220 associated with the personal audio receiver. The audio transducers 220 may receive the equalised audio signal 209 from the personal audio receiver 200 and may reproduce the equalised audio signal 209 as sound.

The audio transducers 220 may be configured to project sound within a short range of the personal audio receiver 200. In some arrangements, the audio transducers 220 may be configured to allow only a user of the personal audio receiver 200 to listen to audio produced by the personal audio receiver 200, for example, the audio transducers 220 may be a pair of headphones, such as over-ear, on-ear, in-ear or earbud headphones. The personal audio receiver 200, may comprise a plug or jack allowing the headphones to be coupled to the personal audio receiver 200 in order to receive the equalised audio signal 209.

The audio transducers 220 may be configured such that the user is able to listen to the ambient, acoustic sound at the location of the user at the same time as the sound being produced by the personal audio receiver 200. For example, if the audio transducers 220 comprise headphones, a body of each headphone may comprise an aperture configured to allow ambient acoustic sound to enter the user's ear canal together with the audio being provided by the personal audio receiver 200. The ambient acoustic sound may include sound being projected by the audio projection equipment 1b and/or the voices of other attendees at the event. Configuring the audio transducers 220 in this way may allow the user to leave the headphones in position within or over their ears during the performance whilst being able to comfortably hear sounds being produced around them, e.g. by other attendees at the performance. Allowing the user to listen to the sound projected by the speakers 16 and/or additional speakers 18 may improve the listening experience of the user, for example, due to the Hass effect described below.

When a person hears substantially the same sound originating from two locations at substantially the same time, e.g. such that the two sounds are separated by less than the person's echo threshold, the person perceived all of the sound as a single fused sound that appears to originate from the location of the sound that was heard first. This psychoacoustic effect is often referred to as the precedence effect or the Haas effect. By allowing ambient sound to enter the ear canal, the personal audio receiver 200 may make use of the Haas effect to create the impression that all of the sound heard by the user is being projected from the speakers 18 or additional speakers 18.

Alternatively, if desirable, the user may listen to the personal, custom audio content in a way that excludes other external noises, for example by using noise cancelling/excluding headphones.

In order for the user of the personal audio mixing device 200 to configure the personal mixer 206 and personal equaliser 208 according to their preferences, the personal audio mixing device 200 may comprise one or more user input devices, such as buttons, scroll wheels, or touch screen devices (not shown). Additionally or alternatively, the personal audio mixing device 200 may comprise a user interface communication module 214.

As shown in FIG. 2, the user interface communication module 214 may be configured to communicate with a user interface device 216. The user interface device may comprise any portable computing device capable of receiving input from a user and communicating with the user interface communication module 214. For example, the user interface device 216 may be a mobile telephone or tablet computer. The user interface communication module 214 may communicate with the user interface device 216 using any form of wired or wireless communication methods. For example, the user interface communication module 214 may comprise a Bluetooth communication module. The personal audio receiver may be configured to connect to, e.g. pair with, the user interface device 216 using wireless communication.

The user interface device 216 may run specific software, such as an app, which provides the user with a suitable user interface, such as a graphical user interface, allowing the user to easily adjust the settings of the personal mixer 206 and personal equaliser 208. The user interface device 216 communicates with the personal audio receiver 200 via the interface communication module 214 to communicate any audio content settings, which have been input by the user using the user interface device 216.

The user interface device 216 and the personal audio mixing device 200 may communicate in real time to allow the user to adjust the mix and equalisation of the audio delivered by the personal audio mixing device 200 during the concert. For example, the user may wish to adjust the audio content settings according to the performer on the stage or a specific song being performed.

The personal audio receiver 200 further comprises a microphone 210. The microphone may be a single channel microphone. Alternatively the microphone may be a stereo or binaural microphone. The microphone 210 is configured to record an ambient sound at the location of the user, for example the microphone may record the sound of the crowd and the sound received by the user from the speakers 16 and additional speakers 18. The sound is converted by the microphone to an acoustic audio signal 211, which may be input to the personal mixer 206. The user of the personal audio mixing device can adjust the relative volume of the acoustic audio signal 211 together with the decoded audio signals 203. This may allow the user of the device 200 to continue experiencing the sound of the crowd at a desired volume whilst listening to the personal audio mix created on the personal audio mixing device 200, particularly when the transducers 220 comprise noise excluding or cancelling headphones.

Prior to being input to the personal mixer 206, the acoustic audio signal 211 is input to an audio processor 212. The audio processor 212 also receives the decoded audio signals 203 from the decoder 204. The audio processor 212 may process the acoustic audio signal 211 and the decoded audio signals 203 to determine a delay between the acoustic audio signal 211 recorded by the microphone 210 and the decoded audio signals received and decoded from the wireless signal 130 transmitted by the multi-channel transmitter 124.

With reference to FIG. 4, in one arrangement of the disclosure, the audio processor 212 is configured to processes the acoustic audio signal 211 and the decoded audio signals 203 according to a method 400. In a first step 402, the acoustic audio signal 211 and the decoded audio signals 211 are processed to produce one or more metadata streams relating to the acoustic audio signal 211 and the decoded audio signals 203, respectively. The metadata streams may contain information relating to the waveforms of the acoustic audio signal and/or the decoded audio signals. Additionally or alternatively, the metadata streams may comprise timing information.

In a second step 404, the audio processor 212 combines the metadata streams relating to one or more of the decoded audio channels to generate a combined metadata steam, which corresponds to the metadata steam generated from the acoustic audio signal. The audio processor 212 may combine different combinations of metadata streams before selecting a combination which it considered to correspond. It will be appreciated that the audio processor 212 may alternatively combine the decoded audio signals 203 prior to generating the metadata streams in order to provide the combined metadata steam.

In a third step 406, the audio processor 212 compares the combined metadata stream with the metadata stream relating to the acoustic audio signal 211 to determine a delay between the acoustic audio signal 211 recorded by the microphone 210, and the decoded audio signals 203.

The audio processor 212 may delay one, some or each of the decoded audio signals 203 by the determined delay and may input one or more delayed audio signals 213 to the personal mixer 206. This allows the personal audio content being created on the personal audio mixing device 200 to be synchronised with the sounds being heard by the user from the speakers 16 and additional speakers 18, e.g. the ambient audio at the location of the user. As noted above, it may be desirable for the personal audio receiver to make use of the Hass effect in order to create the impression that all of the sound being heard by the user is originating from speakers at the event. In this case, the audio processor 212 may delay the decoded audio signals 203 by a period of time that is longer than the calculated delay. The difference between the calculated delay and the delay applied to the decoded audio signals 203 may be sufficiently small that the user does not perceive any echo or reverb effects.

As the user moves around the audience area 4, and the distance between the audience member and the speakers 16, 18 varies, the required delay may vary also. Additionally or alternatively, environmental factors such as changes in temperature and humidity may affect the delay between the acoustic audio signal 211 and the decoded audio signals 203. These effects may be emphasised the further an audience member is from the speakers 16, 18.

In order to maintain synchronisation of the personal audio content created by the device, with the ambient audio, the audio processor 212 may continuously update the delay being applied to the decoded audio signals 203. It may therefore be desirable for the audio processor 212 to reduce the time taken for the audio processor to perform the steps to determine the delay.

As mentioned above, in some arrangements, the audio workstation may be configured to generate at least one of the combined audio signals 128, such that it corresponds to the acoustic audio signal. For example, the combined audio signal 128 may be configured to correspond to the stage mix being projected by the speakers 16, 18. The audio processor 212 may then process only the acoustic audio signal 211 and the decoded audio signal 203 that corresponds to the stage mix, and hence the ambient audio content recorded by the microphone 210 to provide the acoustic audio signal 211.

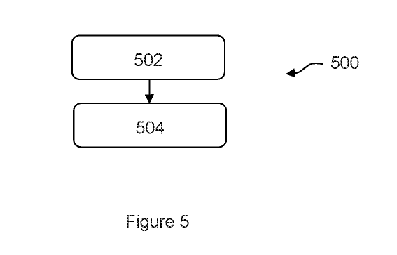

With reference to FIG. 5, in other arrangements of the present disclosure, the audio processor 212 may determine a required delay using a method 500, according to another arrangement of the present disclosure.

In a first step 502, the acoustic audio signal 211 is processed to produce a metadata stream. In a second step 504 the metadata stream relating to the acoustic audio signal is compared with the wirelessly received metadata 205, to determine a delay between the acoustic audio signal 211 and the decoded audio signals 203.

As described above, the metadata 129 transmitted by the multi-channel transmitter 124 and received wirelessly by the personal audio mixer 200 may relate to an audio content generated by the audio workstation that corresponds to the stage mix being projected by the speakers 16, 18. Hence, the wirelessly received metadata 205 may be suitable for comparing with the metadata stream generated from the acoustic audio signal 211 to determine the delay. In addition, by applying the wirelessly received metadata 205 to determine the required delay, rather than processing the decoded audio signals 203 to generate one or more metadata streams, the audio processor 212 may calculate the delay faster. This may lead to improved synchronisation between the personal audio content and the ambient audio heard by the user.

Before a performance begins and/or during intervals or pauses during the event, the operators of the venue, the event promoters and/or the performers due to perform at the event may wish to send information and/or messages to the attendees. For example, the operator of the venue may wish to send messages promoting facilities provided at the event venue and/or the performers may want to share their pre-show preparations with the attendees or provide them with a preview of their performance to increase their excitement prior to the performance.

In some venues, the pre-show messages may be displayed on one or more display screen provided at the venue (not shown) and sound accompanying the pre-show messages may be projected throughout the venue using the speakers and additional speakers 16, 18. When the venue is provided with the audio broadcast equipment 1c, it may be desirable for the sound accompanying the pre-show messages to be broadcast to the attendees in the same way as the sound produced during the performance, as described above.

It may be desirable for some or all of the pre-show messages to be shown only to attendees using one of the personal audio receivers. For example, a performer may wish to send a message to attendees who are using the personal audio receiver 200 to enhance their experience of the performance. In this case, the pre-show message may not be displayed on the display screen provided at the venue and may instead be broadcast to the personal audio receivers 200 using the transmitter 124.

The personal audio receivers 200 may not comprise display screens, and hence, the personal audio receiver 200 may not be able to display a video component of the pre-show message. However, as mentioned above, the personal audio receiver 200 may be paired with a user interface device 216. The user interface device 216 may comprise a display screen, and hence, the personal audio receiver 200 and/or the user interface device 216 is configured to allow the attendees to view the pre-show messages using the user interface device display screen. In other words, the user interface device 216, may be used as a video playback device for the paired personal audio receiver.

The user interface device 216 may comprise an audio transducer or may comprise an audio output configured to allow an audio transducer, such as a pair of headphones, to be coupled to the user interface device 216. Hence, the user interface device may also be capable of playing back the audio component of the media. However, the user may be prepared to listen to the sounds from the audio broadcast equipment 1c using the personal audio receiver 200 and may be wearing headphones coupled to the personal audio receiver. This may be the case particularly if the message is being sent shortly before the start of the concert or during a break in the performance, e.g. between acts. It may be inconvenient for the user to switch between listening to the personal audio device and the user interface device, and hence, it may be desirable to playback the audio component of the media using the personal audio receiver 200, e.g. the audio transducers coupled to the personal audio receiver 200.

With reference to FIG. 3, the personal audio receivers 200 may be configured to show media, such as the pre-show messages, to the attendees using a method 300, according to arrangements of the present disclosure. The method 300 comprises a first step 302 in which the media is received using the personal audio receiver 200. In a second step 304, a video component of the media may be played by the user interface device 216, e.g. using a display screen provided on or associated with the user interface device. In a third step 306 an audio component of the media may be played by the personal audio receiver 200, e.g. using the audio transducers 220. The second and third steps 304, 306 may be performed at substantially the same time. For example, the second and third steps 304, 306 may be performed such that the play back of the audio and video components of the media is substantially synchronised.

As described above, the user interface device 216 may be configured to communicate with the personal audio receiver 200 via the user interface communication module 214. In some arrangements the user interface device 216 may be configured to connect to or pair with the personal audio receiver 200 using a wireless communication system. However, in other arrangements, the personal audio receiver 200 may be connected to the user interface device using a wired connection. Connecting or pairing in these ways may allow two-way communication between the personal audio receiver 200 and the user interface device

The personal audio receiver 200 may be configured to transmit the media or a component of the media, e.g. the video component of the media, to the user interface device 200 using the wireless communication system or he wired connection between the devices.

The first wireless signal received from the transmitter 124 may comprise a plurality of data packets. Each data packet may comprise a portion of the audio component and/or video component of the media. The decoder 204 of the personal audio receiver 200 may decode the plurality of data packets to recover the media, e.g. the audio and video components of the media from the first wireless signal.

In some arrangements, the personal audio receiver 200 and/or the user interface device 216 may be configured to play back the media at substantially the same time that the media is being received by the personal audio receiver. In this arrangement, the decoder 204 may be configured to send the audio component of the media to the personal audio mixer 206 in the same way as the decoded audio signals 203 described above. The video component of the media may be sent from the decoder 204 to the user interface device 216 via the user interface communication module 214. The user interface device 216 may be configured to play back the video component using the display screen of the user interface device 216 at substantially the same time that the media is received.

The process of transmitting the media or the video component of the media to the user interface device 216 may take a significant period of time, e.g. sufficient to lead to an offset or lag, between the play back of the audio component by the personal audio receiver 200 and the playback of the video component by the user interface device 216. The lag may be noticeable to the user. In order to correct for the lag, when the personal audio receiver 200 is receiving and playing back media, the audio processor 212 may be configured to delay the audio component by a predetermined period that is sufficient to allow the playback of the audio and video components to be substantially synchronised.

In some cases it may not be desirable for the media to be played back at substantially the same time that the media is being received by the personal audio receiver 200. For example, it may be desirable for a user to be able to selectively begin play back of the media when they want to view the pre-show message. In this case, it may be desirable for the media to be stored on the personal audio receiver 200 and/or the user interface device 216 in order to be available when playback is requested by the user.

In some arrangements, the personal audio receiver 200 may be provided with sufficient memory to allow the media to be stored on the personal audio receiver 200. Alternatively, the personal audio receiver 200 may have sufficient memory to store the audio component of the media and the video component of the media may be stored on the user interface device 216.

It may be desirable to limit the number of components or modules in the personal audio receiver 200. Hence, in other arrangements, the personal audio receiver 200 may not be provided with sufficient memory to store the media or a component of the media. In this case, the personal audio receiver 200 may be configured to transmit the media, e.g. the audio and video components of the media, to the user interface device 216, e.g. using the user interface communication module 214. The user interface device 216 may have sufficient memory to store the audio and video component of the media.

Although the personal audio receiver 200 may not have sufficient memory to store a component of the media, the personal audio receiver may comprise a buffer memory configured to store one or more packets of data received from the transmitter 124 before the media provided in the data packets is transmitted to the user interface device 216. The buffer memory may be sufficient to store the data received from the transmitter whilst the data is being decoded and/or prepared for transmission to the user interface device 216. Once the media has been transmitted to the user interface device 216, the media may no longer be stored on the personal audio receiver 200.

In the arrangement shown in FIG. 2, the buffer memory may be provided as part of the decoder 204. However, it is equally envisages that the buffer memory may be provided as part of any other component or module of the personal audio receiver 200, such as the user interface communication module 214. Alternatively, the buffer memory may be provided as a separate component or module of the personal audio receiver 200.

As described above, the transmitter 124 may communicate with the personal audio receivers 200 using a broadcast communication system. Accordingly, the transmitter 124 may not be configured to receive acknowledgement messages from the personal audio receivers 200, indicating that they have successfully received the data packets provided within the first wireless signal, before proceeding to send further data packets.

Hence, in some circumstances, a particular personal audio receiver 200 may not receive all of the data packets, e.g. comprising all of the portions of the media, the first time that they are transmitted by the transmitter 124. For example, the user of the personal audio receiver 200 may move out of range of the transmitter 124 during part of the transmission or may move into a position where objects or other attendees between the user and the transmitter 124 degrade the reception of the first wireless signal at the personal audio receiver 200. Additionally, if the pre-show messages are being transmitted at a time when attendees are arriving at the event venue. One or more attendees may arrive at the venue after the start of the pre-show message has been broadcast and may not receive an initial portion of the media.

In order to ensure that each of the attendees having a personal audio receiver 200 is able to successfully receive all of the media data transmitted by the transmitter 124, regardless of intermittent reception, the first wireless signal may be repeated once, twice or several times. The personal audio receiver 200, e.g. the decoder 204, may be configured to decode each packet of data received from the transmitter 124 and store the audio and/or video components of the media, e.g. the portion of the component provided in each data packet, within the memory of the personal audio receiver 200 and/or the user interface device 216. The portions of the components may be stored in the memory or memories such that, after substantially all of the portions of the components have been received, the personal audio receiver 200 and/or the user interface device is able to play back substantially all of the media.

The method 300 may include a step in which a user input is received at the user interface device 216 requesting play back of the media. When the user input is received, the user interface device may begin playing back the video component of the media using the display screen of the user interface device 216.

As described above, in some arrangements the audio component may be stored within a memory of the personal audio receiver 200. When the user input is received, the user input may be transmitted to the personal audio receiver 200, e.g. via the user interface communication module 214. When the personal audio receiver 200 receives the user input, the personal audio receiver may begin playing back the audio component of the media, such that the playback of the audio component and the video component are substantially synchronised.

In other arrangements, in which the audio and video components of the media are stored within a memory of the user interface device 216, when the user input is received, the user interface device 216 may begin transmitting the audio component of the media to the personal audio receiver 200, e.g. via the user interface communication module 214. The personal audio receiver 200 may receive the audio component and may play back the audio component, e.g. using the audio transducers 220. The user interface device 216 and/or the personal audio receiver 200 may be configured such that the playback of the audio component by the personal audio mixer 200 and the playback of the video component by the user interface device 216 is substantially synchronised.

As described above, the personal audio receiver 200 may be connected to or paired with the user interface device 216 using a wireless communication system. At some events, many or all of the attendees may be using a personal audio receiver 200, and hence, configuring the personal audio receiver 200 and/or the user interface device 216 to connect to or pair with each other may be challenging. For example, it may be difficult for a user to ensure that their user interface device 216 is pairing with their personal audio receiver 200.

In order to facilitate the paring of the portable audio receiver and user interface device, the portable audio receiver may be provided with a visual identifier, such as a barcode, two-dimensional barcode or any other visual identifier. The user interface device 216 may comprise a camera. The user interface device 216 may be configured to capture an image of the personal audio receiver 200, e.g. of the visual identifier of the personal audio receiver, using the camera. The user interface device 216 may be configured to process the image to determine an identity of the personal audio receiver 200. The user interface device may pair with the personal audio receiver by applying the determined identity.

Additionally or alternatively, as depicted in FIG. 2, the personal audio receiver 200 may comprise a Near Field Communication (NFC) module 218. The NFC module may comprise an NFC tag which can be read by an NFC reader provided on the user interface device 216. The NFC tag may comprise identifying data which can be read by the user interface device 216, to allow the user interface device to couple with the personal audio mixing device 200, e.g. with the user interface communication module 214. Additionally or alternatively, the NFC tag may comprise authorisation data that can be used by the user interface device 216 to access services provided at the performance venue.

In some arrangements, the NFC module 218 may further comprise an NFC radio. The radio may be configured to communicate with the user interface device 216 to receive the audio content setting from the user interface device, e.g. as an alternative to receiving the audio content setting via the user interface communication module 214. Alternatively, the NFC radio may be configured to read the audio content setting from another source, such as an NFC tag provided on a concert ticket, or smart poster at the venue.

Although the invention has been described by way of example, with reference to one or more examples, it is not limited to the disclosed examples and other examples may be created without departing from the scope of the invention, as defined by the appended claims.

1. A method of presenting media, the method comprising:
receiving, using a receiver, a first wireless signal comprising the media, the media comprising a video component and an audio component;
storing at least a component of the media in a memory of a video playback device separate from the receiver;
selectively playing back the video component of the media using the video playback device; and
playing back the audio component of the media using the receiver such that playback of the audio and video components of the media are synchronised.

2. The method of claim 1, wherein the first wireless signal is transmitted using a first wireless communication system, the first wireless communication system being a broadcast system supporting unidirectional communication.

3. The method of claim 1 or 2, wherein the method further comprises:
transmitting the media from the receiver to the video playback device using a second wireless communication system.

4. The method of claim 3, wherein the receiver is paired with the video playback device by virtue of the second communication system.

5. The method of claim 3 or 4, wherein media is no longer stored on the receiver after being transmitted to the video playback device.

6. The method of any of claims 3 to 5, wherein the receiver includes a buffering memory and wherein the method further comprises:
storing the media within the buffering memory; and
deleting the media from the buffering memory after the media has been transmitted to the video playback device.

7. The method of any of the preceding claims, wherein the method further comprises:
receiving a user input at the video playback device requesting playback of the media.

8. The method of any of the preceding claims, wherein the method further comprises:
transmitting the audio component of the media from the video playback device to the receiver.

9. The method of claim 8 when depending on claim 3, wherein the audio component of the media is transmitted to the receiver using the second wireless communication system.

10. The method according to claim 9, wherein the audio component of the media is transmitted to the receiver at substantially the same time that the video component is played back by the video playback device.

11. The method of claim 4, or any of claims 5 to 10 when depending on claim 4, wherein the video playback device comprises a camera, and wherein the method comprises
capturing an image of the receiver using the camera;
processing the image to determine an identity of the receiver; and
applying the identity of the receiver to pair the video playback device with the receiver using the second wireless communication system.

12. The method of any of the preceding claims, wherein the method further comprises:
transmitting the first signal using a transmitter remote from the receiver.

13. The method of claim 12, wherein the method further comprises:
repeating the transmission of the first signal.

14. An apparatus for presenting media the media comprising an audio component and a video component, the apparatus comprising:
a receiver, configured to receive a first wireless signal comprising the media, the media comprising an audio component and a video component; and
a video playback device separate from the receiver, the video playback device comprising a memory;
wherein the video playback device is configured to store at least a portion of the media in the memory;
wherein the video playback device is configured to playback the video component of the media; and
wherein the receiver is configured to play back the audio component of the media such that the playback of the audio and video components of the media are substantially synchronised.

15. The apparatus according to claim 14, wherein the receiver comprises a first wireless communication system configured to receive the first wireless signal.

16. The apparatus according to claim 14 or 15, wherein the receiver comprises a second wireless communication system;
wherein the receiver is configured to transmit the media to the video playback device using the second wireless communication system.

17. The apparatus according to any of claims 14 to 16, wherein the video playback device comprises a camera and the receiver comprises a visual identifier, wherein the video playback device is configured to capture an image of the visual identifier and process the image to determine an identity of the receiver.

18. The apparatus according to claims 16 and 17, wherein the video playback device is configured to pair with the receiver using the second communication system according to the determined identity of the receiver.

19. The apparatus according to any of claims 14 to 18, wherein the receiver comprises a buffering memory; and
wherein the receiver is configured to:
store the media in the buffering memory when the media is received; and
delete a media from the buffering memory after the media has been transmitted to the video playback device.

20. The apparatus according to any of claims 14 to 19, wherein the video playback device is configured to transmit the audio component of the media to the receiver at substantially the same time that the video component is being played back by the video playback device.

21. A system for presenting media to a plurality of attendees at an event, the system comprising:
a plurality of apparatuses according to any of claims 13 to 20; and
a transmitter configured to broadcast the first wireless signal.

22. An apparatus or system for presenting media substantially as described herein with reference to and as shown in the drawings.

23. A method of presenting media substantially as described herein and with reference to the drawings.
